(19) United States
(12) Patent Application Publication
(10) Pub. No.: US 2025/0229710 A1
(43) Pub. Date: Jul. 17, 2025

(54) EXTERIOR AUDIO ALERT SYSTEM AND METHOD

(71) Applicant: FCA US LLC, Auburn Hills, MI (US)

(72) Inventors: Hongyu Wang, Shanghai (CN); Junjie Zhou, Shanghai (CN); Zuohong Fu, Shanghai (CN); Haifeng Guo, Shanghai (CN); Xiaozhou Jiang, Shanghai (CN)

(21) Appl. No.: 18/414,581

(22) Filed: Jan. 17, 2024

(51) Int. Cl. B60Q 5/00

(52) U.S. Cl. CPC B60Q 5/00

(57) ABSTRACT

A method and system for controlling an exterior audio alert system for a vehicle, the alert system comprising an alert trigger and an auditory signaling device such as a horn. Input from an occupant may include a single operation of the alert trigger, a multi-trigger operation of the alert trigger, or an extended operation of the alert trigger. Depending, for example, on the input and the location of the vehicle, in some scenarios, an inaudible alert or no audio alert is provided via the auditory signaling device.

### FIELD

The present disclosure relates to exterior audio alert systems for vehicles.

### BACKGROUND

Most exterior audio alert systems for vehicles include a horn, with the horn having only a single sound level of about 80 decibels or more. Some vehicle owners may modify their vehicle, and will install an aftermarket horn device to use in place of the original equipment system. Most of these aftermarket devices change the sound of the horn, e.g., by making the auditory alert louder in more advanced sports cars which may have a louder engine noise to counteract. Additionally, these aftermarket devices may require bulky equipment or the like, which could diminish the interior aesthetic of the vehicle. They may also require numerous buttons or the like to adjust the sound, which is not as convenient in actual driving situations.

### SUMMARY

In at least some implementations, there is provided a method and system for controlling an exterior audio alert system for a vehicle, the alert system comprising an alert trigger and an auditory signaling device such as a horn. The horn may be activated via a depressible area or button on a steering wheel of the vehicle. Input from an occupant may include a single operation of the alert trigger, a multi-trigger operation of the alert trigger, or an extended operation of the alert trigger. Depending on the input and/or the location of the vehicle, in some scenarios, an inaudible alert or no audio alert is provided via the auditory signaling device. With the extended operation, a standard audio alert may be sent via the auditory signaling device, and with the multi-trigger operation, an informational audio alert may be sent via the auditory signaling device. The informational audio alert may have a lower decibel level than the standard audio alert, such as 40 decibels or less.

In some implementations, when the single operation of the alert trigger is received, the inaudible alert or the no audio alert may be overridden if the vehicle is outside of an alert-prohibited zone. Additionally, within an alert-prohibited zone, there may be an inaudible alert or no audio alert even with the multi-trigger operation or the extended operation. Alert-prohibited zones may include one or more of a school zone, a hospital zone, and/or a regulatory-prohibited geographic zone.

In some implementations, an occupant can provide an initial input via an infotainment system to selectively control the exterior audio alert system. Multi-mode functionality may be provided in which a single operation of the alert trigger is a press lasting about 0.1 to 2 seconds, inclusive; a multi-trigger operation comprises three or more presses of the alert trigger; and an extended operation comprises a press in a duration of greater than two seconds.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a vehicle interior in accordance with one embodiment; and

FIG. 2 is a schematic view of an exterior audio alert system that can be used in the vehicle of FIG. 1.

### DETAILED DESCRIPTION

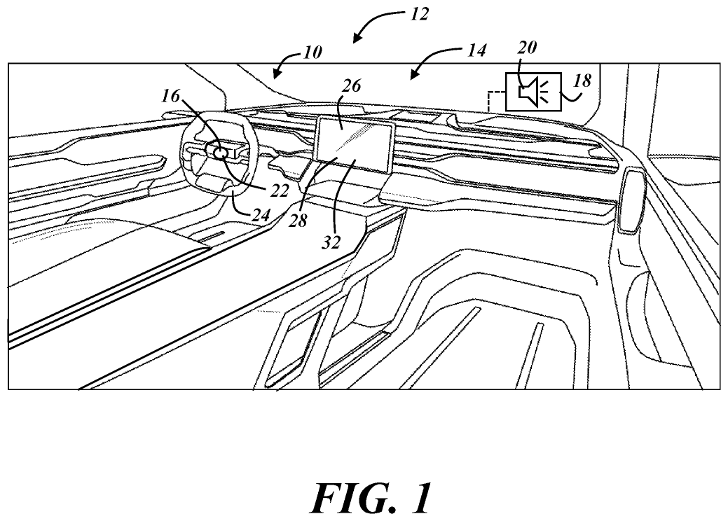

Referring in more detail to the drawings, FIG. 1 illustrates a part of a passenger cabin 10 of a vehicle 12, including an exterior audio alert system 14 having an alert trigger 16 and an auditory signaling device 18. In an advantageous embodiment, the auditory signaling device 18 is a horn 20, with the horn being an original equipment (OE) part that was manufactured and originally sold with the vehicle 12. The exterior audio alert system 14 is configured to provide an auditory alert to pedestrians, other vehicles, individuals, etc. that are outside of the vehicle 12, such as in warning situations or the like. The present disclosure details an exterior audio alert system 14 having a multi-mode audio alert system, which can help reduce the frightening effect of harsh horns on pedestrians, for example, and help avoid unnecessary violations and fines in zones in which honking is prohibited.

In the illustrated embodiment, the alert trigger 16 is a depressible area 22 or button on the steering wheel 24. This configuration is generally more intuitive for the alert trigger 16, but it should be understood that the alert trigger 16 may take other forms, such as a button located elsewhere in the passenger cabin 10, a lever or switch, or via input from the infotainment system 26, to cite a few examples. Having the alert trigger 16 located at a center portion of the steering wheel 24 can help with regulation compliance and vehicle aesthetic (e.g., in the United States, if the alert trigger 16 is located elsewhere, it must be identified in a contrasting fashion with a horn symbol).

The auditory signaling device 18 is configured to project an audio alert from the vehicle 10 upon activation of the alert trigger 16. The auditory signaling device 18 is a horn 20 in the illustrated implementation, which can be used to warn others on or near the roadway or alert others to a potential hazard. The auditory signaling device 18 is typically configured to produce a standard audio alert (whether mechanically, electrically, or some combination thereof) that is in the range of about 80-110 decibels. Larger or louder vehicles may have a standard audio alert that has a greater sound level. This standard audio alert is typically just a fixed, high-decibel sound. It should be understood, however, that the auditory signaling device 18 may include other embodiments besides the explicitly described horn 20 implementation. For example, other sound types are possible, similar to different ring tones of mobile phones, with users being able to download their favorite sound types and can set different types of sounds for the vehicle 12 through the infotainment system 26 or the like. Additionally, it is possible for the auditory signaling device 18 to have multiple outputs (e.g., two horns 20 that have different frequencies or one horn 20 with another speaker-style, amplified, tonal output, etc.).

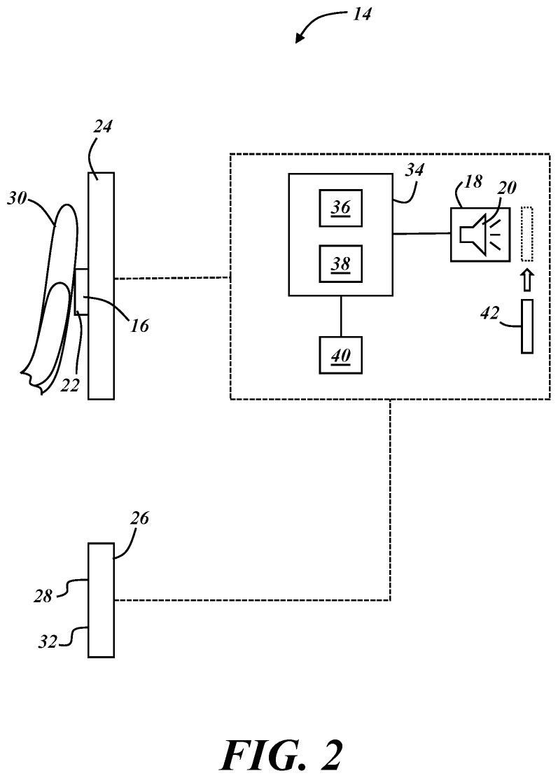

With reference to FIGS. 1 and 2, the infotainment system 26 may have a display 28 or more than one display 28 by which information is provided to one or more occupants 30 of the vehicle 12. The display 28 may be part of an instrument panel or dashboard mounted display by which various information is provided to the driver, such as information relating to a Human-Machine Interface (HMI) 32 that enables use or adjustment of climate controls, radio or other audio systems, interior and exterior lights, control of vehicle cameras, mobile devices (e.g., mobile phones), vehicle settings and the like. In one embodiment, the occupant 30 may be able to provide an initial input via the HMI 32 of the infotainment system 26 to selectively control the exterior audio alert system 14. For example, the exterior audio alert system 14 may work in accordance with a standard operating procedure until the occupant 30 changes a setting via the infotainment system 26 to allow for the multi-mode functionality described herein.

The exterior audio alert system 14 may be configured to work with a controller 34 having a processor 36 and memory 38, along with a location sensor 40, to help facilitate multi-mode functionality. Other inputs to the system 14 are certainly possible, such as inputs from driver assistance and safety systems, which may be part of an Advanced Driver Assistance System (ADAS). Such systems may utilize information from the various sensors and devices of the vehicle 12 to assist or control one or more of vehicle steering and speed. Various object detection and object recognition devices may be included. For example, the vehicle 12 may include one or more of radar, lidar, sonar or other sensors, and these sensors may be used in different ways by different systems of the vehicle 12. In one example, active safety sensors may override a setting in which the auditory signaling device is configured to send an inaudible audio alert or no audio alert in response to activation of the alert trigger 16.

In order to perform the functions and desired processing set forth herein, as well as the computations therefore, the controller 34 may include, but not be limited to, a processor(s) 36, memory 38, and/or other computer(s), DSP(s), storage, register(s), timing, interrupt(s), communication interface(s), and input/output signal interfaces, and the like, as well as combinations comprising at least one of the foregoing. For example, controller 34 may include input signal processing and filtering to enable accurate sampling and conversion or acquisitions of such signals from communications interfaces and sensors. The controller 34 may be a dedicated controller for the exterior audio alert system 14, or it may be a controller that is used for other vehicle-based functionality (e.g., a body control module), or the processing may be distributed between multiple controllers, to cite a few examples.

As used herein the term controller 34 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. The term memory 38 as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory 38 can store an operating system that controls or allocates resources of a computing device, and can store instructions relating to the various functions and programs noted herein and otherwise.

The vehicle location sensor 40 may be a GPS device or component and from this sensor, a location of the vehicle 12 can be determined in real-time and/or at a desired intervals or a desired time. The location sensor 40 and display 28 may be used to indicate a current position of the vehicle 12 on a map. The location sensor 40 may also be used to determine whether the vehicle 12 is in an alert-prohibited zone. In accordance with governmental regulations and/or community guidelines and practices, using the alert trigger 16 or horn 20 may be prohibited in certain areas or zones. Those areas may include, but are not limited to, school zone(s), hospital zone(s), and/or regulatory-prohibited geographic zone(s) (e.g., the Shanghai government prohibits car horn activation in the outer ring, and violators may be fined for triggering the horn 20 in this area). The location sensor 40 may be accordingly used to delineate those zones. For example, such delineation may involve determining whether the vehicle 12 is directly in a zone such as the outer ring in Shanghai, or within a range of a certain zone (e.g., within 500 ft of a school or hospital building could delineate a school or hospital zone).

A method of controlling the exterior audio alert system 14 can be used to provide multi-functional outputs and help avoid instances in which use of the horn 20 is prohibited or may scare pedestrians. In one embodiment, at least three different modes are provided, and the modes may be implemented using various hardware and/or software solutions. The method and system 14 can provide more options for a buyer of the vehicle 12, and may be particularly useful in larger cities where there may be more alert-prohibited zones. Additionally, while other systems may merely decrease the horn 20 volume in different zones (e.g., residential vs. rural or highway), the present system 14 and method can provide enhanced functionality by helping to better avoid situations when an alert is prohibited altogether.

An initial, optional step of the method involves receiving an initial input from the occupant 30 via the infotainment system 26 that the occupant wants to selectively control the exterior audio alert system 14. This may be used as an initial threshold step to determine whether the occupant 30 wants to change the original factory settings of the system 14. For example, the horn 20 may work in accordance with standard operating procedure (e.g., one press on the button 22 will cause activation of horn 20), and then the multi-mode functionality described herein will not be implemented without direct input from the occupant 30. In other embodiments, the vehicle 12 may come with the multi-mode functionality as the standard, factory setting.

In accordance with one embodiment, the method includes three different modes depending at least in part on an input from the occupant 30. The input may include a single operation of the alert trigger 16, a multi-trigger operation of the alert trigger, and/or an extended operation of the alert trigger. The single operation of the alert trigger 16 is a typical or standard press of the button 22 to activate the horn 20. In one example, the single operation of the alert trigger 16 involves an activation by the occupant 30 of about 0.1 to 2 seconds, inclusive. The multi-trigger operation of the alert trigger 16 can include two or more, three or more, or sometimes five or more single operations of the alert trigger 16 within a certain time frame (e.g., 20 seconds or less, or even 10 seconds or less, and this time frame may change or vary depending on the number of activations, such as two activations in four seconds or less or five activations in ten seconds or less, etc.). The extended operation of the alert trigger 16 can include a single operation of the alert trigger which has a longer activation by the occupant 30 than the single operation. For example, in one embodiment, the extended operation of the alert trigger 16 constitutes a continuous press of the button 22 that lasts for more than two seconds. It may be helpful for the single operation input and the extended operation input to share a threshold boundary (e.g., two seconds in this embodiment), which can help more clearly delineate the outputs of the horn 20. In other embodiments, there may not be an overlap between boundaries, or the boundaries may change from what is explicitly described (e.g., single operation is from 0.01 to 1.5 sec, or extended is 3 sec or more, etc.).

With the single operation of the alert trigger 16 (e.g., a quick press of the button 22 to activate the horn 20), the method may output no audio alert or an inaudible audio alert (e.g., no horn 20 activation or activation of the horn 20 that is inaudible to the occupant 30 of the vehicle 12, such as at about 30 dB or less). This disabling or damping of the auditory signaling device 18 can help avoid frightening pedestrians due to mis-operation of pressing the button 22 or inadvertently causing noise in zones where honking the vehicle 12 is prohibited, resulting in potential fines for operation. Additionally, this mode helps avoid situations in which some motor vehicle drivers unconsciously press the horn when encountering situations such as slow-moving vehicles ahead, congested intersections, and pedestrians, thereby avoiding potential road rage scenarios, causing novice drivers to panic, frightening passers-by, or inducing safety hazards. This mode may be implemented electronically in some embodiments (e.g., the controller 34 does not transmit a signal between the trigger 16 and the auditory signaling device 18). In some embodiments, this mode may be implemented mechanically via hardware (e.g., by locking the button 22, insulating or damping the horn 20 output via a movable cover 42, etc.).

In some instances, this disabling of the output from the auditory signaling device 18 (i.e., no audio alert or inaudible audio alert), can be overridden if the vehicle 12 is outside of an alert-prohibited zone. This option selectively limits horn 20 inoperability to situations in which the vehicle 12 is located in an alert-prohibited zone. The alert-prohibited zones can be set manually by the occupant 30, such as via the infotainment system 26 in cooperation with the GPS/location sensor 40. In some implementations, the alert-prohibited zones can be set automatically via software updates, again, in conjunction with the GPS/location sensor 40. In one embodiment, the alert-prohibited zones include school zones, hospital zones, and/or regulatory-prohibited geographic zones. Typically, regulatory-prohibited geographic zones are spatially delineated depending on the statute or regulation that forbids operation of horns 20. School zones and/or hospital zones may also have a regulatory/geographic delineation depending on particular ordinances or the like, or in some embodiments, this may be a setting within the system 14. For example, the system 14 may work in conjunction with the GPS/location sensor 40 to delineate school or hospital zones by circumscribing a predefined radius around each school or hospital by which the vehicle 12 is traveling (e.g., 250 ft or 500 ft from the building). Accordingly, in some embodiments, when the vehicle 12 is not in an alert-prohibited zone, the single operation of the alert trigger 16 may work in accordance with standard operating procedures (e.g., provide a standard audio alert of 80 decibels or more), and then a no alert or inaudible alert may be the output only when the vehicle 12 is within the alert-prohibited zone.

With the multi-trigger operation of the alert trigger 16, the output in one embodiment includes an informational alert. This operation can help avoid the possibility of mis-operation, and let the occupant 30 actively judge whether it is necessary to inform other pedestrians or vehicles within the vicinity of the vehicle 12. The informational alert, as opposed to the standard alert (e.g., 80 decibels or more), advantageously has a decibel level that is lower (e.g., 40 decibels or less, or about half or less of the standard alert sound output). This informational alert, which has a lower sound level as compared to the standard alert, can inform nearby pedestrians or the like without frightening them.

With the extended operation of the alert trigger 16, the output may include a standard alert or a mid-to-high decibel alert. In one embodiment, the mid-to-high decibel alert is higher in sound level than the informational alert, but lower in sound level than the standard alert. With the extended operation, the alert may be used to remind/warn other vehicles in case of an emergency while driving.

In some embodiments, with both the multi-trigger operation and the extended operation, the output may still be a no alert or an inaudible alert, as opposed to the informational alert and standard alert, respectively. This may occur in a situation in which the vehicle 12 is located in an alert-prohibited zone, as detailed herein. Once the vehicle 12 is out of the alert-prohibited zone, as indicated by the location sensor 40 or the like, the multi-mode operational scheme may be implemented, or the auditory signaling device 18 may just go back to standard operation.

What is claimed is:

1. A method of controlling an exterior audio alert system for a vehicle, the exterior audio alert system comprising an alert trigger and an auditory signaling device, the method comprising the steps of:
receiving an input from an occupant of the vehicle, wherein the input includes a single operation of the alert trigger, a multi-trigger operation of the alert trigger, or an extended operation of the alert trigger; and
sending an inaudible audio alert or no audio alert via the auditory signaling device when the single operation of the alert trigger is received.

2. The method of claim 1, wherein, when the extended operation of the alert trigger is received, sending a standard audio alert via the auditory signaling device.

3. The method of claim 1, wherein, when the multi-trigger operation of the alert trigger is received, sending an informational audio alert via the auditory signaling device.

4. The method of claim 3, wherein a decibel level of the informational audio alert is less than a decibel level of a standard audio alert.

5. The method of claim 4, wherein the decibel level of the informational audio alert is 40 decibels or less.

6. The method of claim 1, wherein, when the single operation of the alert trigger is received, overriding the inaudible audio alert or no audio alert when the vehicle is outside of an alert-prohibited zone.

7. The method of claim 6, comprising the step of receiving input from a location sensor to determine when the vehicle is outside of the alert-prohibited zone.

8. The method of claim 7, wherein the alert-prohibited zone includes one or more of a school zone, a hospital zone, and/or a regulatory-prohibited geographic zone.

9. The method of claim 1, wherein, when inside an alert-prohibited zone, sending an inaudible audio alert or no audio alert when the multi-trigger operation of the alert trigger is received or when the extended operation of the alert trigger is received.

10. The method of claim 9, comprising the step of receiving input from a location sensor to determine when the vehicle is inside the alert-prohibited zone.

11. The method of claim 10, wherein the alert-prohibited zone includes one or more of a school zone, a hospital zone, and/or a regulatory-prohibited geographic zone.

12. The method of claim 1, comprising the step of receiving an initial input from the occupant via an infotainment system to selectively control the exterior audio alert system.

13. The method of claim 1, wherein the single operation of the alert trigger comprises a press in a duration of 0.1 to 2 seconds, inclusive.

14. The method of claim 1, wherein the multi-trigger operation of the alert trigger comprises three or more presses of the alert trigger.

15. The method of claim 1, wherein the extended operation of the alert trigger comprises a press in a duration of greater than 2 seconds.

16. An exterior audio alert system for a vehicle, comprising:
an alert trigger configured to be located in a passenger cabin of the vehicle, wherein the alert trigger is configured to be triggered by an occupant of the vehicle; and
an auditory signaling device configured to project an audio alert from the vehicle, wherein the auditory signaling device is configured to send an inaudible audio alert or no audio alert upon a single operation of the alert trigger by the occupant of the vehicle.

17. The exterior audio alert system of claim 16, wherein the alert trigger is a depressible area on a steering wheel of the vehicle and the auditory signaling device is a horn.
